(19) United States
(12) Patent Application Publication
(10) Pub. No.: US 2006/0118355 A1
(43) Pub. Date: Jun. 8, 2006

(54) Pourous sound absorber formed from cork particles and thermally reactive binding agent, and method for the production thereof

(76) Inventors: Heinz Blömeling, Leichlingen (DE); Johannes Hysky, Leichlingen (DE)

Correspondence Address: WILLIAM COLLARD;COLLARD & ROE, P.C., 1077 NORTHERN BOULEVARD, ROSLYN, NY, 11576, US

(21) Appl. No.: 10/553,484

(22) PCT Filed: Feb. 25, 2004
(86) PCT No.: PCT/EP04/01859

§ 371 Date: Jan. 27, 2006

(30) Foreign Application Priority Data
Apr. 17, 2003 (DE) 103 18 136.9

(51) Int. Cl. E04B 1/82; E04B 1/84; G10K 11/16

(52) U.S. Cl. 181/286; 181/294; 181/296

(57) ABSTRACT

The invention relates to a sound absorber, in particular for motor vehicles, and to a method for producing the same. It is the object of the invention to provide an acoustically effective component for motor vehicles, which component not only provides a good sound absorbing effect but also good temperature resistance and good ability to recover or right itself after being subjected to compression. To meet this object, a sound absorber is proposed that is made from an open-pore moulded part (7) made from cork particles and a heat-reactive binder, wherein the percentage of binder in the moulded part (7) is at most 1 to 20% by weight. According to the invention the sound absorber is produced in such a way that the cork particles with the heat-reactive binder are placed in a hollow space (4) of a moulding tool designed in the manner of an injection moulding tool. Hardening of the binder is preferably triggered by the binder being subjected to water vapour (20) in the hollow space (4) of the moulding tool (1).

The invention relates to a sound absorber, in particular for motor vehicles, which is made from a porous moulded part made from cork particles and a heat-reactive binder, as well as to a method for manufacturing such a sound absorber in which cork particles with a heat-reactive binder are placed in a moulding tool, and hardening of the binder is triggered by the effect of heat.

In order to reduce the sound emission emanating from motor vehicles a multitude of sound dampening or sound absorbing components have already been developed. These are in particular acoustically effective linings in the engine compartment and in the wheel housings, which linings are subjected to relatively high temperatures or mechanical loads resulting from stones being thrown up. Components made of plastic, for example of expanded polypropylene, have only a very modest ability to recover or restore themselves in the case of compressive stress or stones being thrown up. Other requirements which such components have to meet further include the lightest possible weight in view of the fact that fuel consumption generally increases as the weight of a vehicle increases, and the ability to be produced economically, both in conjunction with good acoustic effectiveness.

From DE 37 30 208 A1 a porous moulded shape is known which comprises a mixture of cork granulate and an adhesive, baked at low ambient pressure with the admission of heat, wherein the mixture additionally comprises sawdust and pine needles or crushed pine needles. The cork granulate comprises crushed cork of a grain size ranging from 1 to 2 mm as well as coarse cork flour. A urea condensation polymer is used as an adhesive. The percentage of adhesive in the moulded shape is 25% by weight. The moulded shape also comprises a covering of cold-setting adhesive. The moulded shape is in particular used as a backing for inserting plant parts. As an alternative, this moulded shape is also said to be used as a heat insulating and sound absorbing construction panel. However, the sound-absorbing effect of this moulded shape is likely to be only moderate.

It is the object of the present invention to create an acoustically effective component for motor vehicles, which component not only comprises a good sound-absorbent effect but also good temperature resistance and good ability to recover or restore itself after being subjected to pressure. Furthermore, the component should be of relatively light weight and should be economical to produce.

This object is met by the sound absorber according to the invention with the features of claim 1. The sound absorber according to the invention comprises a porous moulded part produced from cork particles and a heat-reactive binder, which moulded part is of an open-pore design, wherein the percentage of binder in the moulded part is at most 1 to 20% by weight.

Cork is a material which provides the sound absorber with a temperature resistance that is significantly better than that of many plastic materials, in particular better than that of sound absorbers made from expanded polypropylene (EPP). Furthermore, cork has an excellent ability to recover or restore itself. This is advantageous in particular in relation to stones being thrown against it, when the sound absorber according to the invention is for example used to line a wheel housing. Moreover, cork is a raw material that re-grows, and cork particles are available economically, and these factors make it possible to produce components of the type of interest in the context of this patent specification without any waste. Generally, cork has acoustically effective pores, in particular micropores.

In the sound absorber according to the invention, the cork particles and the heat-reactive binder are selected and dimensioned such that the moulded shape made from them is of an open-pore construction with coarse pores. This produces a good sound-absorbing effect. The percentage of the binder in the moulded part can preferably be as low as 1 to 10% by weight, and in particular as low as 1 to 5% by weight.

Furthermore, it is the object of the invention to state a method for producing such a sound absorber. This object is met by the method with the characteristics of claim 25.

The method according to the invention is essentially characterised in that the cork particles together with the heat-reactive binder are placed in a hollow space of a moulding tool designed in the manner of an injection moulding tool, wherein the ratio of cork particles to binder is selected such that the percentage of binder in the finished porous moulded part is at most 1 to 20% by weight. Hardening of the binder is preferably triggered by the binder being subjected to water vapour in the hollow space of the moulding tool.

An advantageous embodiment of the invention consists of a moulding tool being used which comprises several suction pipes that can be controlled independently of each other, with each suction pipe communicating with the hollow space of the moulding tool by way of a suction aperture, wherein the suction apertures are arranged so as to be spaced apart from each other, and with the suction performance of the individual suction pipes being set differently so that the cork particles in different sections of the hollow space of the moulding tool are subjected to compression of different magnitude. In this way a situation can be achieved in which the finished moulded part according to the invention has sections of different density and/or different porosity. In this way it is possible to match the moulded part and thus the sound absorber to the respective local noise intensity distributions and frequency spectra, and thus to achieve optimum sound absorption.

In this context a preferred embodiment of the invention provides for a moulded part according to the invention to be produced by a moulding tool comprising several supply lines arranged at a distance from each other, by way of which supply lines cork granulates can be selectively supplied to the hollow space of the moulding tool, which cork granulates differ as far as their average grain size and/or grain size distribution are/is concerned.

A further preferred embodiment of the sound absorber according to the invention provides for said sound absorber to comprise at least one layer made of a non-woven material, foam material, heavy layer material and/or textile fabric. The layer or layers can preferably be connected to the porous moulded part by way of the binder of said porous moulded part.

The sound absorber according to the invention can in particular be a wheel housing lining; subfloor lining; roof lining; internal door lining; car body pillar cover; engine compartment lining; bonnet lining; boot lining; boot cover; interior lining of the vehicle floor, in particular carpet substructure; transmission tunnel lining; or rear parcel shelf.

Further preferred and advantageous embodiments of the invention are stated in the subordinate claims.

Below, the invention is explained in more detail by means of a drawing showing several embodiments. The following are diagrammatically shown:

FIGS. 1 to 4 various work steps in the production of a sound absorber according to the invention by means of a moulding tool prepared for this purpose;

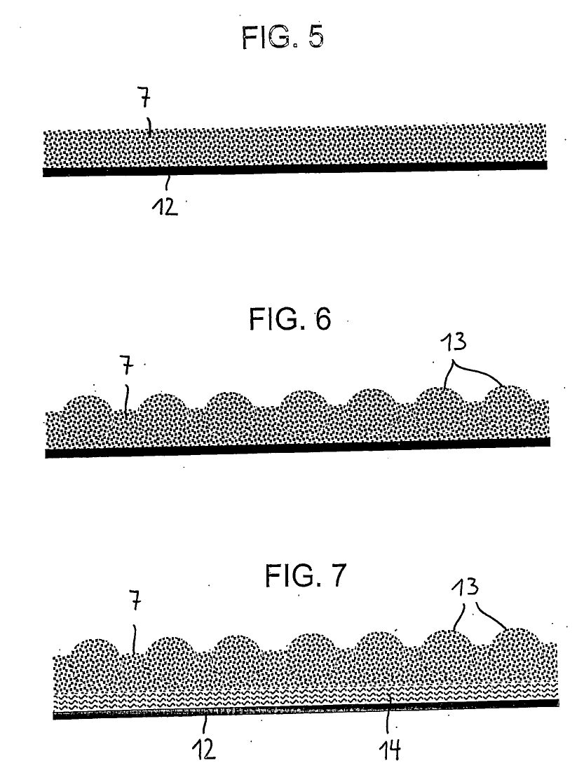

FIG. 5 a sectional view of a sound absorber according to the invention according to a second embodiment;

FIG. 6 a sectional view of a sound absorber according to the invention according to a third embodiment;

FIG. 7 a sectional view of a sound absorber according to the invention according to a fourth embodiment;

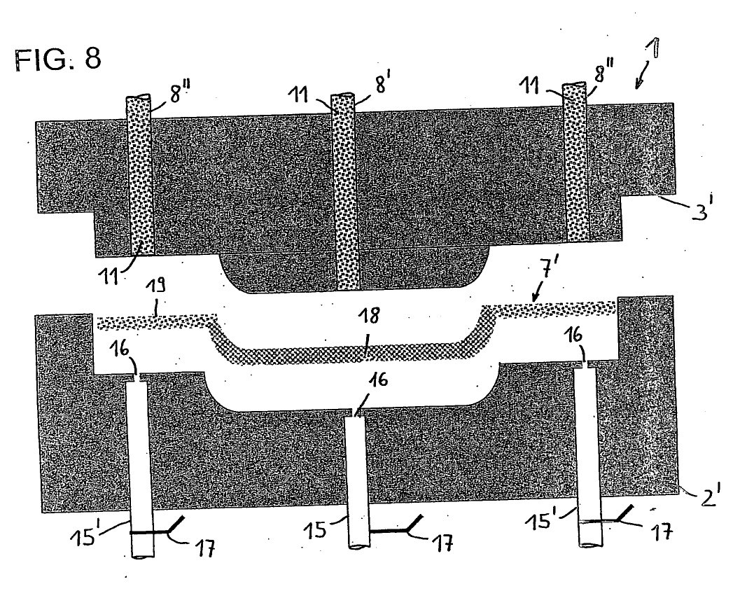

FIG. 8 a sectional view of a further moulding tool for producing a sound absorber according to the invention according to a fifth embodiment;

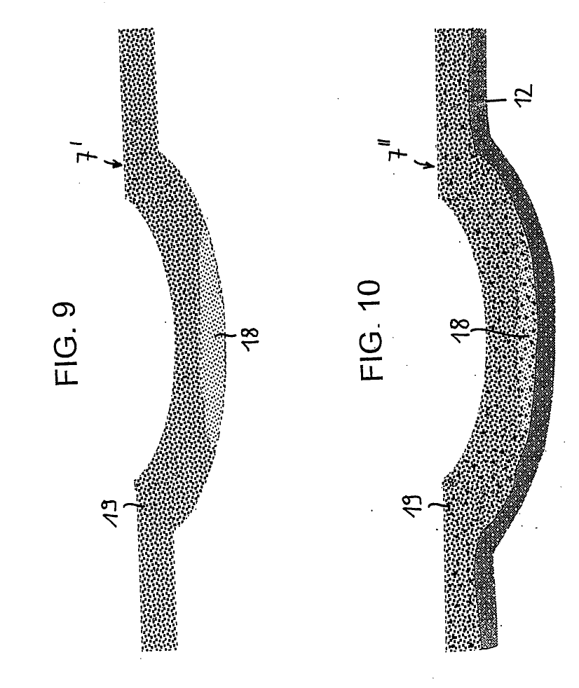

FIG. 9 a sectional view of a sound absorber according to the invention according to a sixth embodiment; and

FIG. 10 a sectional view of a sound absorber according to the invention according to a seventh embodiment.

The moulding tool 1 shown in FIGS. 1 to 4 is designed in the manner of an injection moulding tool and comprises a bottom tool 2 and a top tool 3, with the latter being able to be raised and lowered. The bottom tool 2 comprises a hollow space 4 that is open on one side, which hollow space 4 can be closed by the top tool 3. The lower side of the top tool 3 is provided with a mould profile 5 which together with the mould profile 6 of the bottom tool 2 defines the form or contour of the moulded part 7 to be produced.

The top tool 3 comprises a supply line 8 which leads to the region of its mould profile 5. By way of said supply line 8 a moulding material can be placed in the hollow space 4 of the closed moulding tool 1. The bottom tool 2 comprises a distributor chamber 9 which communicates, by way of several channels 10 of relatively small diameter, with the hollow space 4 of the moulding tool, which hollow space 4 accommodates the moulding material.

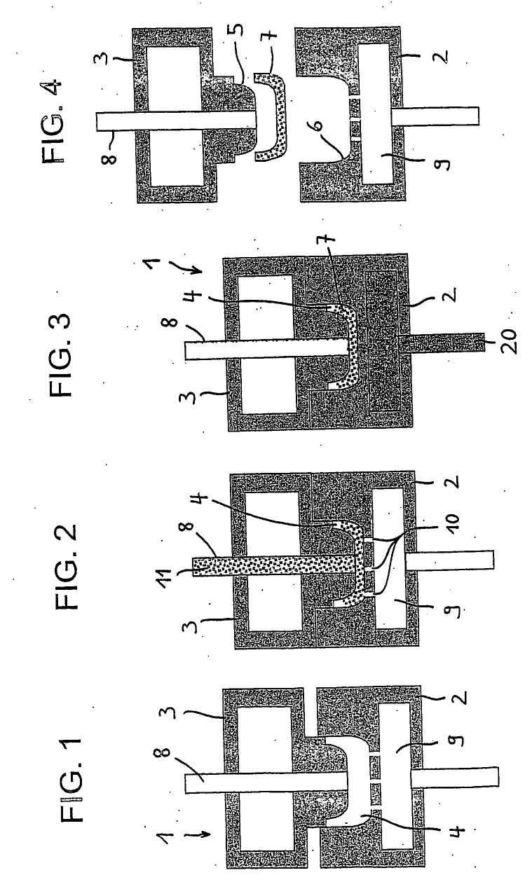

FIG. 1 shows a situation in which the moulding tool is closed by lowering the top tool 3. In the closed state of the moulding tool 1 a moulding material 11 comprising cork granulate and a heat-reactive binder is placed in the hollow space 4 (FIG. 2) by way of the supply line 8. Placement of the moulding material is carried out pneumatically, for example by way of air injection. As an alternative or as a supplement, the moulding material 11 comprising cork granulate and binder can be aspirated into the hollow space 4. In this case a suction fan (not shown) or the like is connected to the distributor chamber 9 of the bottom tool 2.

The average grain size of the cork granulate ranges from 2 to 8 mm. Good results are achieved in particular with cork granulate of an average grain size ranging from 3 to 6 mm.

The cork granulate and the binder can be placed into the moulding tool 1 as a mixture. In this process the binder is essentially a dry granulate or powder. However, it is also possible to use cork particles which already prior to placement in the hollow space 4 of the moulding tool 1 have been at least partly encased with binder.

The heat-reactive binder is preferably a binder based on urea, melamine or polyacrylate. In particular a duroplastic binder in the form of a heat-reactive acrylate resin that is thermoplastically mouldable prior to cross-linking can be used as a binder. Such an acrylate resin is for example available from BASF AG under the trade name of Acrodur®. The binder is preferably free of any formaldehyde.

After the hollow space 4 of the moulding tool 1 has been filled with the moulding material 11 comprising cork particles and heat-reactive binder, the supply line 8 is closed off where it leads to the hollow space 4, and the moulding material 11 which is still located in the supply line 8 is removed or suck off from the region directly adjacent to the hollow space 4. However, it is also possible to supply moulding material 11 in batches at a quantity required for producing each moulded part 7.

Subsequently the distributor chamber 9, and thus the moulding material 11 situated in the hollow space 4, is subjected to hot water vapour so that hardening of the heat-reactive binder is triggered (compare FIG. 3, in which the water vapour, coloured black, is designated by the reference number 20).

After the binder has completely or at least largely hardened, the moulding tool 1 is opened by raising the top tool 3, and the finished open-pore moulded part 7 is removed from the tool 1 (FIG. 4). Solidification of the open-pore moulded part 7 can be supported by cooling the moulding tool 1 and/or the moulded part 7 by means of a liquid coolant, e.g. cool air.

The percentage of binder in the moulded part 7 is at most 1 to 20% by weight. As far as the porosity and stability of the moulded part 7 are concerned, experiments have returned good results with a binder percentage of 1 to 10% by weight, in particular 1 to 5% by weight.

The hardened binder is elastic. It has a temperature resistance of at least 90° C., preferably at least 120° C. In particular, a binder can be used which in its hardened state has a temperature resistance of approximately 180° C.

In principle, the sound absorber according to the invention can simply comprise an open-pore moulded part 7, made from cork particles and a heat-reactive binder. The porosity of the moulded part 7 is relatively high. It is preferably at least 20%, in particular at least 30%. The average grain size and the grain size distribution of the cork particles are selected such that the finished porous moulded part 7 comprises a length-specific flow resistance ranging from 5 kPas/m² to 50 kPas/m². Preferably the grain size distribution is selected such that the length-specific flow resistance of the moulded part 7 ranges from 8 kPas/m² to 20 kPas/m².

FIGS. 5 to 7 show three different embodiments of a sound absorber according to the invention, each comprising an open-pore moulded part 7 made of cork particles and a heat-reactive binder.

In the sound absorber shown in FIG. 5, on one side the open-pore moulded part is covered by a layer 12 made of heavy layer material. The sound absorber, which in this embodiment is essentially panel-shaped, can be produced in one work step, wherein the cover layer or backing 12 made of heavy layer material is placed in the hollow space of a corresponding moulding tool or is produced therein by injection moulding. The cover layer or backing 12 is subsequently coated by injection and/or aspiration of the moulding material which comprises cork granulate and a binder. Instead of a layer of heavy layer material, if required, a layer comprising non-woven material, foam and/or textile fabric can be coated in this way with cork particles and a binder. The moulded part 7 and the layer 12 made of a non-woven material, foam, textile fabric or heavy layer material are interconnected by the heat-reactive binder contained in the moulding material. The cover layer or backing 12 can be an open-pore material layer or a material layer that is permeable to gas, or it can be an essentially gas-proof, and in particular waterproof, material layer.

The sound absorber shown in FIG. 6 differs from the embodiment according to FIG. 5 in that on the exposed side of the open-pore moulded part 7 there are elevations 13. In this embodiment the elevations 13 are in the shape of hemispherical projections or neps which are essentially arranged in a grid. It is understood that the elevations 13 can also comprise other shapes, for example the shape of pyramids, cones, cylinders, right parallelepipeds, cubes and/or webs. It also falls within the scope of the invention to arrange or shape the elevations 13 in different densities and/or geometric dimensions.

In the embodiment shown in FIG. 7 between the mat-shaped porous moulded part 7 and the cover layer 12 made of heavy layer material an intermediate layer 14 comprising a non-woven material or a foam material is arranged. Preferably the non-woven material comprises melt fibres and/or thermoplastic fibres.

FIG. 8 diagrammatically shows a further embodiment of a moulding tool for producing a sound absorber according to the invention. The moulding tool 1′ is again designed in the manner of an injection moulding tool, wherein in this embodiment the top tool 3′ that can be raised and lowered comprises several supply lines 8′, 8″, arranged so as to be spaced apart from each other, by way of which the moulding material that comprises cork granulate and a heat-reactive binder can selectively be supplied to the hollow space 4 of the form tool 1′. The bottom tool 2′ comprises several suction pipes 15, 15′, each of which communicates with the hollow space 4 of the moulding tool 1′ by way of at least one suction aperture 16. In this arrangement the suction apertures 16 are arranged so as to be spaced apart from each other. The suction lines 15, 15′ comprise electromechanical slides 17, which are controllable independently of each other. By means of the slides 17 the suction performance can be set on the suction pipes 15, 15′ at different levels so that the cork particles that are encased with binder are compressed differently in different locations within the moulding tool 1′. In this way open-pore moulded parts 7′ are generated which comprise sections 18, 19 of different porosity and flow resistance.

In FIG. 8 a way of production is indicated in which the suction performance of the middle suction line 15 has been set to be higher than that of the two outside suction lines 15′. Accordingly, the compression of the cork granulate in the middle section 18 of the moulded part 7′ is greater than that in the outlying regions 19 of the moulded part.

Furthermore, it is possible by way of the supply lines 8′, 8″ to selectively supply cork particles which differ as far as their average grain size and/or grain size distribution are/is concerned. For example, by way of the middle supply line 8′ a cork granulate of a relatively small average grain size, for example a cork granulate of an average grain size of 2 to 4 mm, can be supplied, while by way of the other supply lines 8″ at the same time or sequentially a cork granulate of a larger average grain size, for example an average grain size of 5 to 8 mm can be supplied. In this way, open-pore moulded parts 7′, 7″, can be produced as diagrammatically shown in FIGS. 8 to 10.

The sound-absorbing moulded part 7″ according to FIG. 10 differs from the porous moulded part 7′ according to FIG. 9 in that a cover layer 12 made of a porous non-woven material or a foam material is present. As already mentioned, the cover layer 12 can be placed in the moulding tool 1′ and can be back-blown or coated by the moulding material comprising cork particles and a heat-reactive binder. In FIGS. 9 and 10 the reference numbers 18 and 19 designate regions of different grain size distribution and thus different porosity.

The sound absorber according to the invention is in particular destined as a sound-absorbing component for installation in motor vehicles. Due to its good temperature resistance it can for example be used as a transmission cover and/or as a dashboard lining on the engine side. Its use as a sound-absorbent wheel housing lining is another preferred area of application. It goes without saying that the sound absorber according to the invention is furthermore also suited for other areas of application in motor vehicles. For example, said sound absorber can also be designed as an engine cover, bonnet insulation, subfloor lining, carpet substructure, cover of the interior of doors, roof lining, roof pillar cover, rear parcel shelf and/or boot lining. If the moulded part according to the invention is exposed to conditions of moisture or wetness, it can preferably comprise a waterproof but sound-permeable layer and/or it can be finished with a hydrophobic impregnating agent which can in particular be admixed to the binder. For example, a thin plastic film or aluminium foil can be used as a waterproof layer.

Implementation of the present invention is not limited to the embodiments described above. Instead, several variants are imaginable which even in the case of a fundamentally different design make use of the inventive idea as stated in the claims.

1-40. (canceled)

41. A sound absorber, in particular for motor vehicles, which is made from a porous open-pore moulded part (7, 7′, 7″) made from cork particles and a heat-reactive binder, wherein the moulded part (7, 7′, 7″) has a length-specific flow resistance ranging from 5 kNs/m⁴ to 50 kNs/m⁴, wherein the percentage of binder in the moulded part amounts to a maximum of 1 to 20% by weight.

42. The sound absorber according to claim 41, wherein the percentage of binder in the moulded part (7, 7′, 7″) is 1 to 10% by weight or 1 to 5% by weight.

43. The sound absorber according to claim 41, wherein the porous moulded part (7, 7′, 7″) has a porosity of at least 20%, preferably of at least 30%.

44. The sound absorber according to claim 41, wherein the porous moulded part (7, 7′, 7″) is formed from a cork granulate having an average grain size in a range from 2 to 8 mm, preferably in a range from 3 to 6 mm.

45. The sound absorber according to claim 41, wherein the porous moulded part (7, 7′, 7″) has a length-specific flow resistance ranging from 8 kNs/m⁴ to 20 kNs/m⁴.

46. The sound absorber according to claim 41, wherein the porous moulded part (7′, 7″) comprises sections of different density and/or different porosity.

47. The sound absorber according to claim 41, wherein the porous moulded part (7′, 7″) comprises sections of cork granulate of different grain size distribution and/or sections of different flow resistance.

48. The sound absorber according to claim 41, wherein the binder is elastic in its hardened state.

49. The sound absorber according to claim 41, wherein the binder is a binder whose hardening cab be triggered by water vapour (20).

50. The sound absorber according to claim 41, wherein the binder has a temperature resistance of at least 120° C., in particular of approximately 180° C.

51. The sound absorber according to claim 41, wherein the binder is a duroplastic binder which is thermoplastically mouldable prior to cross-linking.

52. The sound absorber according to claim 41, wherein the porous moulded part (7) comprises elevations (13) in the shape of projections or neps, pyramids, cones, cylinders, right parallelepipeds, cubes and/or webs.

53. The sound absorber according to claim 52, wherein the elevations (13) are arranged in a grid or in different density.

54. The sound absorber according to claim 41, wherein it comprises at least one layer (12, 14) made of a non-woven material, foam material, heavy layer material and/or textile fabric.

55. The sound absorber according to claim 54, wherein the porous moulded part (7, 7″) and the layer (12, 14) made of a non-woven material, foam material, heavy layer material and/or textile fabric are interconnected by the binder.

56. The sound absorber according to claim 41, wherein the porous moulded part (7, 7′, 7″) comprises a waterproof sound-permeable layer and/or is provided with a hydrophobic impregnant.

57. A method for producing a porous sound absorber, in particular for motor vehicles, in which cork particles with a heat-reactive binder are placed in a moulding tool (1, 1′) and hardening of the binder is triggered by the effect of heat, wherein the cork particles with the binder together as a moulding material are placed in a hollow space (4) of a moulding tool (1, 1′) designed in the manner of an injection moulding tool, wherein the ratio of cork particles to binder is selected such that the percentage of binder in the finished porous moulded part (7, 7′, 7″) amounts to a maximum of 1 to 20% by weight, and in that the average grain size and the grain size distribution of the cork particles are selected such that the finished porous moulded part (7, 7′, 7″) has a length-specific flow resistance in a range from 5 kNs/m⁴ to 50 kNs/m⁴.

58. The method according to claim 57, wherein the ratio of cork particles to binder is selected such that the percentage of binder in the moulded part (7, 7′, 7″) is 1 to 10% by weight or 1 to 5% by weight.

59. The method according to claim 57, wherein the binder in the hollow space (4) of the moulding tool (1, 1′) is subjected to water vapour (20).

60. The method according to claim 57, wherein the moulding tool (1′) comprises several suction pipes (15, 15′) that can be controlled independently of each other, with each suction pipe (15, 15′) communicating with the hollow space (4) of the moulding tool (1′) by way of a suction aperture (16), wherein the suction apertures (16) are arranged so as to be spaced apart from each other, and wherein the suction performance of the suction pipes (15, 15′) is set differently so that the cork particles in different sections of the hollow space (4) of the moulding tool (1′) are subjected to compression of different magnitude.

61. The method according to any one of claims 57, wherein the moulding tool (1′) comprises several supply lines (8′, 8″) arranged at a distance from each other, by way of which supply lines (8′, 8″) cork granulates can be selectively supplied to the hollow space (4) of the moulding tool (1′), which cork granulates differ as far as their average grain size is concerned.

62. The method according to any one of claims 57, wherein a cover layer or backing (12, 14) made of a non-woven material, foam material, heavy layer material and/or textile fabric is placed in the hollow space (4) of the moulding tool (1, 1′) or is produced therein, wherein the cover layer or backing (12, 14) is subsequently coated by injection and/or aspiration of the cork particles and the binder.

63. The method according to claim 57, wherein solidification of the moulded part (7, 7′, 7″) is supported by cooling the moulding tool (1, 1′) and/or the moulded part (7, 7′, 7″) by means of a liquid coolant.

64. The method according to claim 57, wherein the cork particles, as far as their grain size and the ratio of cork particles to binder are concerned, are selected such that the finished porous moulded part (7, 7′, 7″) has a length-specific flow resistance ranging from 8 kNs/m⁴ to 20 kNs/m⁴.
